(19) United States
(12) Patent Application Publication
(10) Pub. No.: US 2026/0203233 A1
(43) Pub. Date: Jul. 16, 2026

(54) MANAGING A CACHE USING PER-SCHEDULING UNIT LINKED LIST DATA STRUCTURES

(71) Applicant: Dell Products L.P., Round Rock, TX (US)

(72) Inventors: Vladimir Shveidel, Pardes-Hana (IL); Erez Sharvit, Ramat Gan (IL)

(21) Appl. No.: 19/023,917

(22) Filed: Jan. 16, 2025

(51) Int. Cl. G06F 12/123; G06F 9/48

(52) U.S. Cl. CPC G06F 12/123; G06F 9/4881; G06F 2212/1024

(57) ABSTRACT

Techniques are provided for managing a cache using one or more linked list data structures for each scheduling unit. One method comprises receiving, by a cache management system that manages a cache memory, a cache access request comprising a target address for accessing data; managing, by the cache management system, at least one linked list data structure for each scheduling unit of a storage server; initiating, by the cache management system, a cache access operation to determine whether the target address corresponds to a cache entry; and in response to determining that the target address corresponds to a cache entry, (i) accessing, by the cache management system, the cache entry to obtain cache data from the cache memory, (ii) returning the obtained cache data to a requesting cache client and (iii) updating the at least one linked list data structure.

### BACKGROUND

Cache memories improve performance by storing, for example, recently and/or frequently used data items. Cache memories often employ an eviction policy. A least recently used (LRU) eviction policy, for example, replaces an LRU cache entry, with the assumption that more recently used cache entries are more likely to be accessed again in the near future.

### SUMMARY

Illustrative embodiments of the disclosure provide techniques for managing a cache using one or more linked list data structures for each scheduling unit. An exemplary method comprises receiving, by a cache management system, a cache access request comprising a target address for accessing data, wherein the cache management system manages at least one cache memory; managing, by the cache management system, cache management system, at least one linked list data structure for each scheduling unit of a plurality of scheduling units of a storage server; initiating, by the cache management system, a cache access operation to determine whether the target address corresponds to a cache entry; and in response to determining that the target address corresponds to a cache entry, (i) accessing, by the cache management system, the cache entry to obtain cache data from the at least one cache memory, (ii) returning the obtained cache data to a requesting cache client and (iii) updating the at least one linked list data structure.

Illustrative embodiments can provide significant advantages relative to conventional techniques. For example, problems associated with managing latency associated with resource requests are overcome in one or more embodiments by maintaining a linked list data structure for each scheduling unit of a storage server.

Other illustrative embodiments include, without limitation, apparatus, systems, methods and computer program products comprising processor-readable storage media.

### BRIEF DESCRIPTION OF THE DRAWINGS

FIG. 1 illustrates a network computing environment that can be configured for managing a cache using one or more linked list data structures for each scheduling unit in accordance with an illustrative embodiment;

FIG. 2 illustrates a storage data server of FIG. 1 in further detail in accordance with an illustrative embodiment;

FIG. 3 illustrates exemplary pseudocode for an LRU linked list management process in accordance with an illustrative embodiment;

FIG. 4A illustrates an exemplary cache entry in accordance with an illustrative embodiment;

FIG. 4B illustrates an exemplary set of data structures associated with a scheduling unit in accordance with an illustrative embodiment;

FIG. 5 illustrates exemplary pseudocode for a cache entry allocation process in accordance with an illustrative embodiment;

FIG. 6 illustrates exemplary pseudocode for a cache entry removal/eviction process in accordance with an illustrative embodiment;

FIG. 7 illustrates exemplary pseudocode for a cache entry access process in accordance with an illustrative embodiment;

FIG. 8 illustrates exemplary pseudocode for an LRU linked list rebalancing process in accordance with an illustrative embodiment;

FIG. 9 is a flow diagram illustrating an exemplary implementation of a method for managing a cache using one or more linked list data structures for each scheduling unit in accordance with an illustrative embodiment;

FIG. 10 illustrates an exemplary processing platform that may be used to implement at least a portion of one or more embodiments of the disclosure comprising a cloud infrastructure; and

FIG. 11 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for managing a cache using one or more linked list data structures for each scheduling unit.

In one or more embodiments, techniques are provided for managing a cache using one or more linked list data structures for each scheduling unit. As noted above, an eviction policy is typically implemented by maintaining a linked list of elements (e.g., a double linked list), wherein each linked list element is mapped to a cache entry. An LRU linked list, for example, is often implemented as a double linked list having head and tail positions. A linked list operation typically requires a spinlock protection with both lock contention and an enforcing memory barrier with a high rate that dramatically increases RAM bandwidth utilization. A spinlock refers to a lock that causes a thread trying to acquire the lock to wait in a loop (e.g., “spin”) while continuing to check if the lock is available. The thread attempting to acquire the lock remains active as it performs such repeated checks on the availability of the lock, until the lock is acquired. Thus, among other inefficiencies, spinlock protection wastes compute cycles for spinning and additional latencies.

Storage flows often require access to metadata pages. Thus, linked list operations are called with a high rate from different flows and contexts. A cost of performing such linked list operations is therefore important for overall performance of a storage cluster.

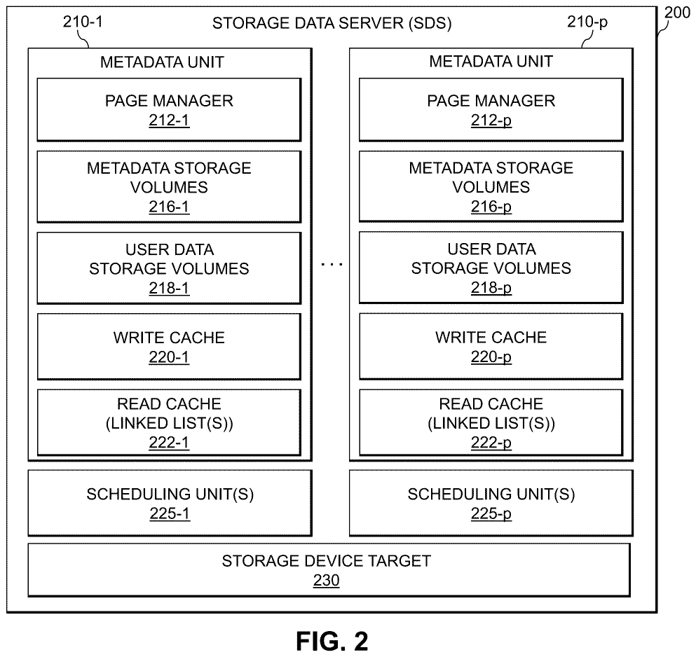

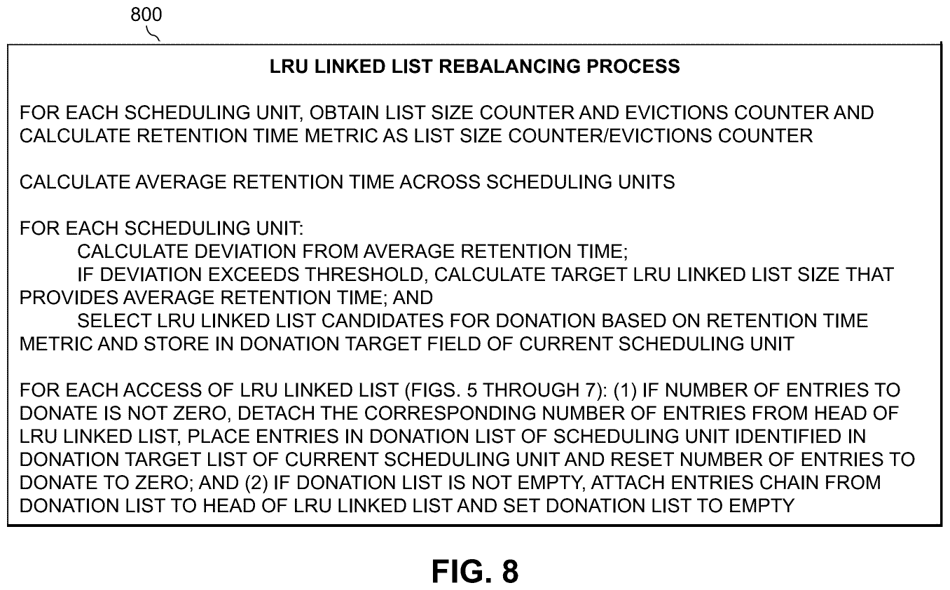

In one or more embodiments, techniques are provided for managing a cache using one or more linked list data structures for each scheduling unit, as discussed further below in conjunction with FIG. 2, for example. The disclosed linked list partitioning mechanism, with a linked list for each scheduling unit, provides an improved (e.g., fairer) retention policy. In addition, a lockless rebalancing of the linked lists is also provided, as discussed further below in conjunction with FIG. 8, for example.

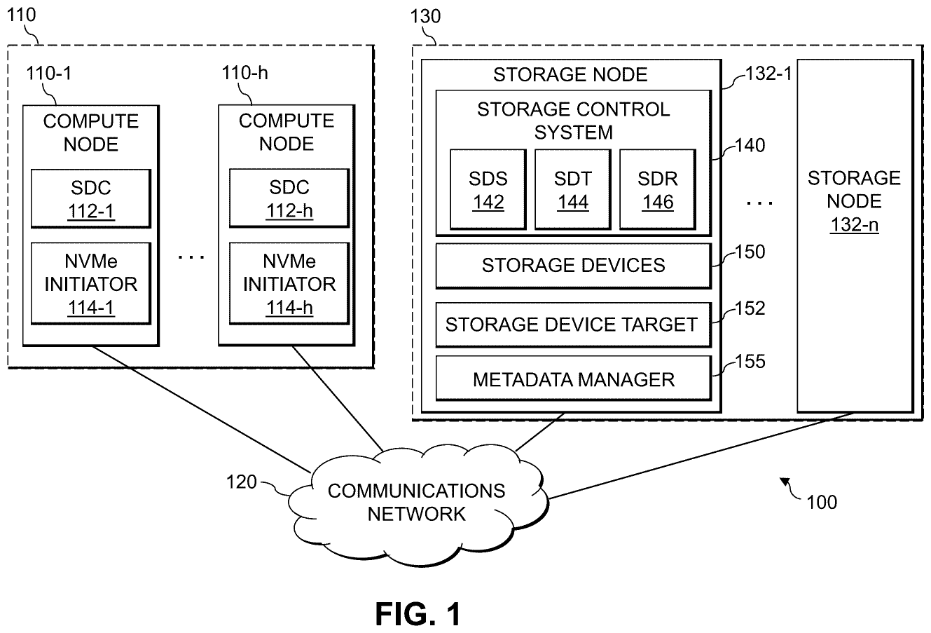

FIG. 1 schematically illustrates a computing environment 100 that can be configured for managing a cache using one or more linked list data structures for each scheduling unit, according to an exemplary embodiment of the disclosure. In particular, FIG. 1 schematically illustrates one or more compute nodes 110-1 . . . 110-h (collectively, compute nodes 110), a communications network 120 and a data storage system 130 comprising a plurality of storage nodes 132-1 . . . 132-n (collectively, storage nodes 132).

In some embodiments, each compute node 110-1 . . . 110-h respectively comprises a storage data client (SDC) 112-1 . . . 112-h and a non-volatile memory express (NVMe) initiator 114-1 . . . 114-h (or NVMe initiator 114), the functions of which will be explained below.

As further shown in FIG. 1, the storage node 132-1 comprises a storage control system 140, storage devices 150, a storage device target 152 and a metadata manager (MDM) 155. The storage device target 152, for example, of a given storage node 132 can be a backend target configured to manage storage devices 150 and to coordinate a processing of I/O operations on one or more of the storage devices 150.

In some embodiments, the storage control system 140 is a software-defined storage control system that comprises a storage data server (SDS) 142, a storage data target (SDT) 144 and a storage data replicator (SDR) 146, the functions of which will be explained below. In some embodiments, the other storage nodes (e.g., storage node 132-n) have the same or similar configuration as the storage node 132-1 shown in FIG. 1. The SDT 144 can be a front-end target that is a software component configured to provide support for one or more communication protocols.

The compute nodes 110 may comprise physical server nodes and/or virtual server nodes that host and execute applications that are configured to process data and execute tasks/workloads and perform computational work, either individually, or in a distributed manner, to thereby provide compute services to one or more users (the term “user” herein is intended to be broadly construed so as to encompass numerous arrangements of human, hardware, software or firmware entities, as well as combinations of such entities, including clients and/or application programming interfaces employed by the user). In some embodiments, the compute nodes 110 comprise application servers, database servers, etc. The compute nodes 110 can include virtual nodes such as virtual machines and container systems. In some embodiments, the compute nodes 110 comprise a cluster of computing nodes of an enterprise computing system, a cloud-based computing system, or other types of computing systems or information processing systems comprising multiple computing nodes associated with respective users. The compute nodes 110 issue data access requests to the data storage system 130, wherein the data access requests include (i) write requests to store data in one or more of the storage nodes 132 and (ii) read requests to access data that is stored in one or more of the storage nodes 132.

The communications network 120 is configured to enable communication between the compute nodes 110 and the storage nodes 132, as well as peer-to-peer communications between the storage nodes 132. In this regard, while the communications network 120 is generically depicted in FIG. 1, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., IP-based or Fiber Channel storage fabric), or various portions or combinations of these and other types of networks. In this regard, the term “network” as used herein is therefore intended to be broadly construed so as to encompass a wide variety of different network arrangements, including combinations of multiple networks possibly of different types, that enable communication using, e.g., Transfer Control Protocol/Internet Protocol (TCP/IP) or other communication protocols such as Fibre Channel (FC), FC over Ethernet (FCOE), RDMA over Converged Ethernet (RoCE), Internet Small Computer System Interface (iSCSI), Peripheral Component Interconnect express (PCIe), InfiniBand, Gigabit Ethernet, etc., to implement I/O channels and support storage network connectivity. Numerous alternative networking arrangements are possible in a given embodiment, as will be appreciated by those skilled in the art.

In some embodiments, each storage node 132 comprises a server node (e.g., storage-only node) that is implemented on, e.g., a physical server machine or storage appliance comprising hardware processors, system memory, and other hardware resources that execute software and firmware to implement the functionality of the storage node 132 and the associated storage control system 140. In some embodiments, each storage node 132 comprises a plurality of control processors that execute a lightweight operating system (e.g., a customized lightweight Linux kernel) and functional software (e.g., software-defined storage software) to implement functions of the storage control system 140, as discussed in further detail below.

The storage devices 150 of a given storage node 132 can be internal storage devices and/or direct-attached storage devices, and may comprise one or more of various types of storage devices such as hard-disk drives (HDDs), solid-state drives (SSDs), flash memory cards (e.g., PCIe cards), or other types of non-volatile memory (NVM) devices including, but not limited to, non-volatile random-access memory (NVRAM), phase-change RAM (PC-RAM), magnetic RAM (MRAM), and other types of storage media, etc. In some embodiments, the storage devices 150 comprise flash memory devices such as NAND flash memory, NOR flash memory, etc. The NAND flash memory can include single-level cell (SLC) devices, multi-level cell (MLC) devices, triple-level cell (TLC) devices, or quad-level cell (QLC) devices. These and various combinations of multiple different types of storage devices 150 may be implemented on each storage node 132. In this regard, the term “storage device” as used herein should be broadly construed to encompass all types of persistent storage media including hybrid drives. On a given storage node 132, the storage control system 140 is configured to communicate with the storage devices 150 through any suitable host interface, e.g., a host bus adapter, using suitable protocols such as Advanced Technology Attachment (ATA), serial ATA (SATA), external SATA (eSATA), parallel ATA (PATA), non-volatile memory express (NVMe), small computer system interface (SCSI), serial attached SCSI (SAS), peripheral component interconnect express (PCIe), etc.

The data storage system 130 may comprise any type of data storage system, or a combination of data storage systems, including, but not limited to, a storage area network (SAN) system, a dynamic scale-out data storage system, or other types of distributed data storage systems comprising software-defined storage, clustered or distributed virtual and/or physical infrastructure. The term “data storage system” as used herein should be broadly construed and not viewed as being limited to storage systems of any particular type or types. In some embodiments, the data storage system 130 comprises a dynamic scale-out storage system that allows additional storage nodes to be added (or removed) to the cluster to scale the performance and storage capacity of the data storage system 130. It is to be noted that each storage node 132 and associated storage devices 150 is an example of what is more generally referred to herein as a “storage system” or a “storage array.”

In some embodiments, the data storage system 130 comprises a dynamic scale-out software-defined storage system that is configured to implement a high-capacity block-level SAN storage system (e.g., virtual SAN system) that consolidates the capacity of the storage devices 150 (e.g., HDDs, SSDs, NVMe flash storage, flash PCIe cards etc.) of the storage nodes 132 into shared block storage that is logically partitioned into logical storage volumes identified by, e.g., logical unit numbers (LUNs). In an exemplary embodiment of a scale-out software-defined SAN storage system, the storage control systems 140 comprise software components of a software-defined storage system, that are executed on the storage nodes 132 to implement a software-defined storage environment in which the storage nodes 132 form a loosely coupled storage server cluster and collectively communicate and operate to create a server-based SAN system (e.g., virtual SAN) to provide host access to a virtual pool of block storage using the combined storage capacity (e.g., storage devices 150) of the storage nodes 132.

In some embodiments, the SDCs 112, the MDMs 155, the SDSs 142, the SDTs 144, and the SDRs 146, for example, of the storage nodes 132 comprise software components of a software-defined storage platform, wherein the software components are installed on physical server machines (or server nodes) such as application servers, storage servers, control servers, etc. In some embodiments, virtual machines (e.g., Linux-based virtual machines) are utilized to host the software components of the software-defined storage platform. The software components collectively implement various functions for deploying and managing a software-defined, scale-out server SAN architecture that can grow from a few servers to thousands of severs.

For example, the SDS 142 comprises a service that is configured to manage the storage capacity (e.g., storage devices 150) of a single server (e.g., storage node 132) and provide back-end access to the storage devices of the server. In other words, the SDS 142 is installed on each server that contributes some or all of the capacity of its local storage devices to the scale-out data storage system. More specifically, in the scale-out software-defined storage environment, the SDSs 142 of the storage control systems 140 are configured to create and manage storage pools (e.g., virtual pools of block storage) by aggregating storage capacity of the respective storage devices 150 and dividing each storage pool into one or more volumes, wherein the volumes are exposed to the SDCs 112 of the compute nodes 110 as virtual block devices. For example, a virtual block device can correspond to a volume of a storage pool. Each virtual block device comprises any number of actual physical storage devices, wherein each virtual block device is preferably homogenous in terms of the type of storage devices that make up the block device (e.g., a block device can include only HDD devices or SSD devices, etc.). In this regard, each instance of the SDS 142 that runs on a respective one of the storage nodes 132 contributes some or all of its local storage space to an aggregated virtual pool of block storage with varying performance tiers (e.g., HDD, SSD, etc.) within a virtual SAN.

In some embodiments, each SDC 112 that executes on a given compute node 110 comprises a lightweight block device driver that is deployed to expose shared block volumes to the compute nodes 110. An SDC 112 may expose one or more designated test volumes, discussed further below. In particular, each SDC 112 is configured to expose the storage volumes as block devices to the applications located on the same server (e.g., application server) on which the SDC 112 is installed. In other words, as shown in FIG. 1, the SDCs 112 run on the same server machines as the compute nodes 110 that require access to the block devices exposed and managed by the SDSs 142 of the storage nodes 132. The SDC 112 of a given compute node 110 exposes block devices representing the virtual storage volumes that are currently mapped to the given compute node 110. In particular, the SDC 112 for a given compute node 110 serves as a block driver for the compute node 110, wherein the SDC 112 intercepts I/O requests, and utilizes the intercepted I/O request to access the block storage that is managed by the SDSs 142. The SDCs 112 are installed in the operating system or hypervisor hosting the application layer and provide the operating system or hypervisor (that runs the SDC 112) access to the logical block devices (e.g., volumes). The SDCs 112 have knowledge of which SDSs 142 hold its block data, so multipathing can be accomplished natively through the SDCs 112, where the communications network 120 is configured to provide an any-to-any connection between the compute nodes 110 and the storage nodes 132. More specifically, each SDC 112 connects to every SDS 142, which eliminates the need for multipath software, in at least some embodiments.

In some embodiments, the MDMs 155 implement a management layer on one or more of the storage nodes 132 that manages and configures the software-defined storage system in the computing environment 100. The MDMs 155 are services that function as a monitoring and configuration agent of the storage environment. More specifically, in some embodiments, the management layer is configured to supervise the operations of the storage cluster and manage storage cluster configurations. For example, the MDMs 155 (or an MDM cluster) manage the storage system by aggregating the entire storage exposed to the MDM cluster by the SDSs 142 to generate a virtual storage layer (e.g., virtual SAN storage layer), wherein logical volumes can be defined over storage pools and exposed to host applications as a local storage device using the SDCs 112.

Further, the MDMs 155 are configured to manage various types of metadata associated with the software-defined storage system. For example, such metadata includes a mapping of the SDCs 112 to the SDSs 142 of the storage nodes 132, wherein such mapping information is provided to the SDCs 112 and the SDSs 142 to allow such components to control I/O data path operations (e.g., allow the SDCs 112 to communicate with target SDSs 142 to access data in logical volumes that are mapped to the SDCs 112). In addition, the MDMs 155 collect connectivity status updates from the SDCs 112 to monitor all connections between SDCs 112 and the SDSs 142 to determine the current system state, and post events whenever a given SDC 112 connects to or disconnects from a specific IP address of a given SDS 142.

In addition, the MDMs 155 may be configured to manage various management operations such as data migration, rebuilds, and other system-related functions. In this regard, the MDMs 155 generate and manage various types of metadata that are required to perform various management operations in the storage environment such as, e.g., performing data migration operations, performing rebalancing operations, managing configuration changes, managing the SDCs 112 and the SDSs 142, maintaining and updating device mappings, maintaining management metadata for controlling data protection operations such as snapshots, replication, RAID configurations, etc., managing system capacity including storage device allocations and/or release of capacity, performing operations for recovery from errors and failures, and system rebuild tasks, etc. The MDMs 155 communicate with the SDCs 112 to provide notification of changes in data layout, and communicate with the SDSs 142 to coordinate rebalancing operations. In some embodiments, the MDMs 155 are configured to implement a distributed cluster management system.

In some embodiments, the software-defined storage system utilizes various logical entities that link the physical layer to the virtual storage layer, wherein such logical entities include protection domains, fault sets, and storage pools. In some embodiments, a protection domain is a logical entity that comprises a group of SDSs 142 that provide backup for each other. Each SDS 142 belongs to only one protection domain such that each protection domain comprises a unique set of SDSs 142. In some embodiments, each protection domain can have up to a maximum number of SDS nodes (e.g., 128 SDS nodes). The use of protection domains enables optimal performance, reduction of mean time between failure (MTF) issues, and the ability to sustain multiple failures in different protection domains.

Further, in some embodiments, a fault set is a logical entity that defines a logical group of SDS nodes (within a protection domain) that are more inclined to fail together, e.g., a group of SDS nodes within a given protection domain that are all powered in a same rack. By grouping SDS nodes into a given fault set, the system is configured to mirror the data for all storage devices in the given fault set, wherein mirroring is performed on SDS nodes that are outside the given fault set. A fault unit can be either a fault set or an SDS node that is not associated with a fault set. In some embodiments, user data is maintained in a RAID-1 mesh mirrored layout, where each piece of data is stored on two different fault units. The copies are distributed over the storage devices according to an algorithm that ensures uniform load of each fault unit in terms of capacity and expected network load.

Moreover, in some embodiments, a storage pool is a logical entity that defines a set of physical storage devices in a protection domain, wherein each storage device belongs to only one storage pool. When a volume is configured over the virtualization storage layer, in some embodiments, the volume is distributed over all devices residing in the same storage pool. Each storage pool comprises a homogeneous set of storage devices (e.g., HDD storage pool, or SSD storage pool) to enable storage tiering. In some embodiments, each volume block has two copies located on two different fault units (e.g., two different SDS nodes), that allows the system to maintain data availability following a single-point failure.

The SDR 146 is a software component that is configured to implement a data replication system, e.g., journal-based asynchronous replication. In some embodiments, asynchronous replication is performed between two peer data storage systems, which are connected via a WAN. In general, in some embodiments, asynchronous replication involves writing data to a source (primary) volume in a first data storage system and acknowledging completion of an I/O write operation to a host application before the data is replicated to a target (replica) volume in a second (remote) data storage system (e.g., the source (primary) volume and the target (replica) volume do not share hardware elements in at least some embodiments). With asynchronous replication, the I/O write operations at a source storage node are logged in a replication journal by a source SDR 146 on the source storage node, and the replication journal is periodically transmitted at scheduled times to a target storage node, wherein a target SDR 146 on the target storage node processes the received replication journal to replicate data to a target (replica) volume. The data replication system can be utilized for various purposes including, but not limited to, recovering from a physical or logical disaster, migrating data, testing data at a remote site, or offloading a data backup operation.

More specifically, in the exemplary embodiment of FIG. 1, the SDR 146 is responsible for processing all I/O requests associated with replicated volumes. In the source system, for replicated volumes, the SDCs 112 communicate with the SDR 146. For non-replicated volumes, the SDCs 112 communicate directly with the SDSs 142. At a source storage node, application I/O requests associated with a replicated volume are sent in some embodiments by an SDC 112 to a source SDR 146. The source SDR 146 will write the required journal data to a replication journal volume, and then send a duplicate of the replication I/O write request and associated user data to the SDS 142 wherein the SDS 142 performs write operations to write the received I/O user data in a primary volume. The journal data is then transmitted to a target SDR 146 on a target storage node, which processes the received replication journal to replicate data to the target (replica) volume. In some embodiments, a minimum of two SDRs are deployed on the source and target storage nodes to maintain high availability. If one SDR fails, the management layer (e.g., one or more MDM nodes) directs the SDCs to send the I/O requests for replicated volumes to an available SDR 146.

The SDT 144 can be a front-end target that is a software component configured to provide support for, for example, NVMe-oF, in particular, NVMe over TCP (NVMe/TCP) that enables NVMe-oF across a standard Ethernet network. In some embodiments, the SDT 144 is configured in the storage layer to handle the I/O requests of the NVMe initiators 114 to provide support for the NVMe/TCP storage protocol for front end connectivity, and thus, allow the use of NVMe/TCP hosts in addition to the SDCs 112. In some embodiments, the SDT 144 is an NVMe target that is configured to translate control and I/O data path packets to the NVMe standard protocol, wherein each NVMe initiator 114 is serviced by multiple SDTs 144 depending on the supported number of paths in the NVMe multipathing driver. In essence, I/O requests are sent from a host NVMe initiator 114 (which is installed in the host operating system or hypervisor) to the SDT 144, and the SDT 144 communicates with a target SDS 142 to direct the I/O request to the target SDS 142.

A distributed storage system may employ user data storage volumes for storing user data, and metadata storage volumes for storing the metadata corresponding to the user data. The metadata associated with a given SDS may be managed by one or more metadata units. The ownership of the user data storage capacity may be spread among multiple metadata units. The number of metadata units on a given SDS may vary. The different metadata units on an SDS may each have a different number of metadata pages at a given time. In order to provide a scalable system, one or more aspects of the disclosure recognize that the metadata storage volumes should start at a designated size and be expandable to support additional metadata pages.

FIG. 2 illustrates an SDS of FIG. 1 in further detail in accordance with an illustrative embodiment. An SDS is sometimes referred to herein as a storage server and is considered to be part of a data path of a storge node. In the example of FIG. 2, an SDS 200 comprises one or more metadata units 210-1 . . . 210-p (collectively, metadata units 210), one or more scheduling units 225-1 . . . 225-p (collectively, scheduling units 225) and a storage device target 230. In some embodiments, metadata unit 210-1 comprises a respective page manager 212-1, one or more metadata storage volumes 216-1, one or more user data storage volumes 218-1, a write cache 220-1 and a read cache 222-1. Similarly, metadata unit 210-p comprises a respective page manager 212-p, one or more metadata storage volumes 216-p, one or more user data storage volumes 218-p, a write cache 220-p and a read cache 222-p. The metadata storage volumes 216 and the user data storage volumes 218 are configured to store metadata pages and user data pages, respectively, and may also store additional information, such as checkpoints and write journals.

The write cache 220 may be used to improve performance by using a volatile memory (e.g., RAM) to gather write commands sent to a storage device 150. The read cache 222 maintains the most frequently accessed data and metadata pages in memory and avoids an excessive repeating read operations of such pages from a persistent storage. Typically, all read pages remain in the cache and are removed if the page becomes invalid or if it is needed to free space for new page allocations. LRU is one strategy for choosing a page to evict (e.g., the page that was accessed least recently). The LRU strategy ensures that the read cache 222 contains the most frequently accessed pages. The read cache 222 also maintains one or more linked lists associated with an eviction policy, such as LRU linked lists. For example, a first linked list is maintained by metadata unit 210-1 as a component of the read cache 222-1. The read caches 222 may be individual read caches from a large read cache pool in some embodiments. Each metadata unit 210-i can access any read cache page but allocates cache pages from its own respective read cache 222-i.

The scheduling units 225 comprises a queue of user threads that execute one or more I/O operations of a metadata unit 210 associated with the scheduling unit, where only one user thread can execute at a time. One or more scheduling units 225 may be associated with a given metadata unit 210-i. In at least some embodiments, each scheduling unit 225 is associated with one linked list.

As noted above, a storage device target 230 of a given SDS 200 can be a backend target configured to manage storage devices and to coordinate a processing of I/O operations on such storage devices.

The page manager 212 splits the metadata storage volumes 216 into metadata pages (not shown in FIG. 2), and processes requests to allocate and deallocate metadata pages on a metadata storage volume. In some fault scenarios, the page manager 212 may rebuild the metadata stored in one or more of the metadata storage volumes 216. Generally, a metadata page characterizes a plurality of user data pages stored on user data storage volumes 218. For example, in a given set of user data pages, each of the user data pages may be characterized by a storage volume identifier, an offset and possibly a signature.

A given “page” as the term is broadly used herein should not be viewed as being limited to any particular range of fixed sizes. In some embodiments, a page size of 8 kilobytes (KB) is used, but this is by way of example only and can be varied in other embodiments. For example, page sizes of 4 KB, 16 KB or other values can be used. Accordingly, illustrative embodiments can utilize any of a wide variety of alternative paging arrangements for organizing the metadata pages and/or the user data pages.

The user data pages are part of the user data storage volumes 218 (e.g., LUNs) configured to store files, blocks, objects or other arrangements of data, each also generally referred to herein as a “data item,” on behalf of users. The user data stored in the user data pages can include any type of user data that may be utilized in the computing environment 100. The terms “metadata page” and “user data” herein are therefore also intended to be broadly construed.

While one or more embodiments of the disclosed techniques for managing a cache using linked list data structures for each scheduling unit are illustrated using LRU linked lists associated with an LRU eviction policy, the disclosed per-scheduling unit linked list cache management techniques may be employed using another eviction policy, such as a least frequently used (LFU) eviction policy, a least frequent recently used (LFRU) eviction policy, a time aware least recently used (TLRU) eviction policy or a Segmented LRU (SLRU) eviction policy, among others, or combinations thereof, as would be apparent to a person of ordinary skill in the art.

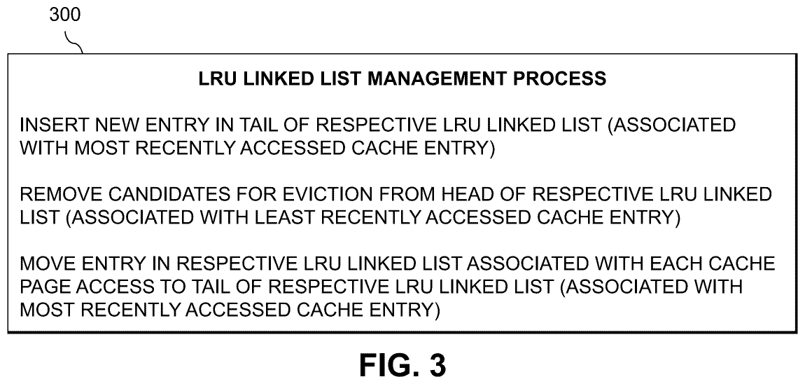

FIG. 3 illustrates exemplary pseudocode 300 for an LRU linked list management process in accordance with an illustrative embodiment. Cache memories often employ an LRU eviction policy that replaces an LRU cache entry, with the assumption that more recently used cache entries are more likely to be accessed again in the near future. An LRU eviction policy is implemented by maintaining a linked list of elements, where each linked list element is mapped to a cache entry and is ordered using the most recent access time.

In the example of FIG. 3, a new cache entry is inserted in a tail of the respective LRU linked list (e.g., associated with the most recently accessed cache entry). Candidates for eviction are removed from the head of the respective LRU linked list (e.g., associated with the least recent accessed cache entry).

In addition, an entry in the respective LRU linked list associated with each cache page access is moved to a tail of the respective LRU linked list (e.g., associated with the most recently accessed cache entry).

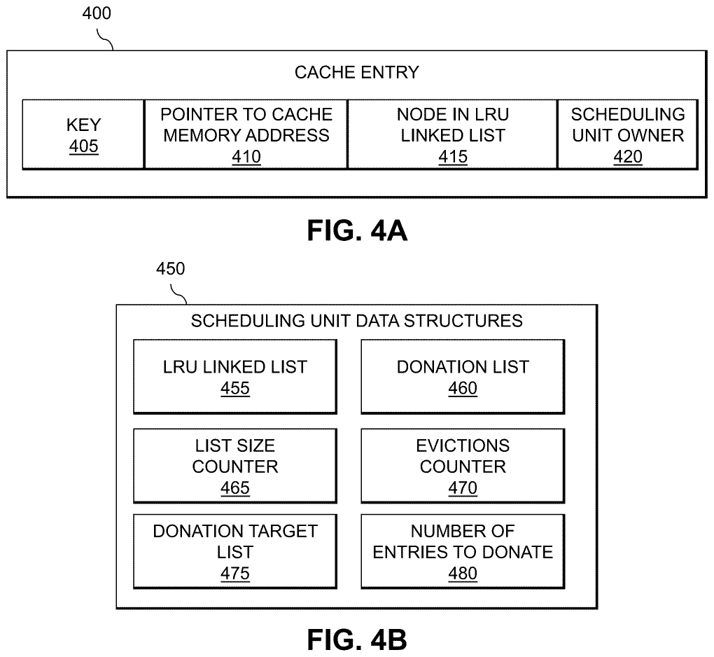

FIG. 4A illustrates an exemplary cache entry 400 in accordance with an illustrative embodiment. In the example of FIG. 4A, each cache entry 400 comprises a key 405 that stores a key for the given cache entry; a pointer 410 to a cache memory address that contains the associated cached data; a node 415 in the LRU linked list (e.g., comprising a next pointer and a previous pointer for a double linked list); and an identifier of a scheduling unit owner 420 that allocated the cache entry 400.

FIG. 4B illustrates an exemplary set of data structures 450 associated with a scheduling unit in accordance with an illustrative embodiment. In the example of FIG. 4B, the set of data structures 450 comprises an LRU linked list 455; a donation list 460; a list size counter 465; an evictions counter 470; a donation target list 475; and a number of entries to donate 480.

As noted above, the LRU linked list 455 (e.g., a double linked list having head and tail positions) comprises a linked list of elements, where each linked list element is mapped to a cache entry. The donation list 460 comprises a listing of LRU linked list entries donated from other threads as part of a rebalancing of the LRU linked lists, as discussed further below in conjunction with FIG. 8, for example. The list size counter 465 indicates a current size (e.g., number of entries) of the LRU linked list 455 (updated each time a cache entry is added to or removed from the LRU linked list 455).

The evictions counter 470 represents a number of LRU eviction events (e.g., incremented on each eviction from the LRU linked list 455, such as when the cache is full and an entry is needed for a new entry). The donation target list 475 comprises a listing of selected LRU linked list entries that are candidates for donation to another thread. The number of entries to donate 480 represents a value of the list size counter 465 minus an average retention time across scheduling units, multiplied by the evictions counter 470, as discussed further below in conjunction with FIG. 8.

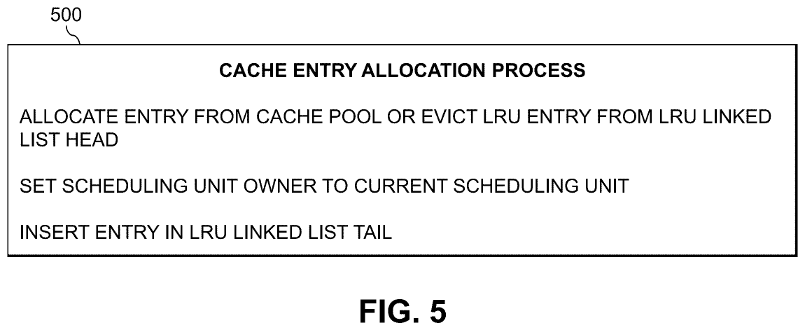

FIG. 5 illustrates exemplary pseudocode for a cache entry allocation process 500 in accordance with an illustrative embodiment. In the example of FIG. 5, to allocate a cache entry, an entry is either allocated from the cache pool, if available, or an LRU entry is evicted from a head position of the LRU linked list (associated with the most recently accessed cache entry).

In addition, the scheduling unit owner of the cache entry is set to the current scheduling unit doing the allocation. Finally, an entry is inserted in a tail position of the LRU linked list.

For example, in response to a cache miss, the cache may: allocate a new page or entry (for example, from the cache pool, or by evicting an entry from the LRU entry at the head of the LRU linked list); initiate a reading of the corresponding page from a backend storage device (e.g., from a persistent storage media or drive) to the newly allocated cache page; and return the cache data. Among other benefits, the operations of FIG. 5 do not require a spinlock (since only one user thread is executed at a time).

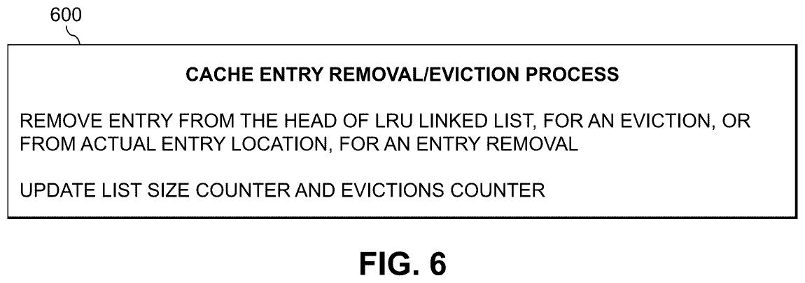

FIG. 6 illustrates exemplary pseudocode for a cache entry removal/eviction process 600 in accordance with an illustrative embodiment. In the example of FIG. 6, a cache entry is removed entry from a head position of the LRU linked list, for an eviction, or from the actual cache entry location, for an entry removal. In addition, the list size counter 465 and the evictions counter 470 are updated accordingly.

It is noted that the operations of FIG. 6 do not require a spinlock (since only one user thread is executed at a time).

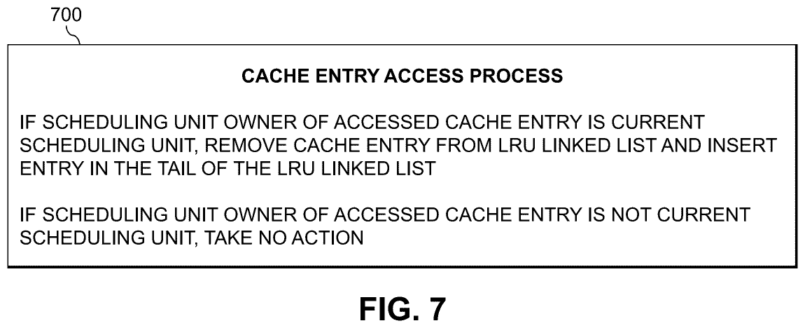

FIG. 7 illustrates exemplary pseudocode for a cache entry access process 700 in accordance with an illustrative embodiment. In the example of FIG. 7, a cache entry is accessed, if the scheduling unit owner 420 of the accessed cache entry is the current scheduling unit performing the access, by removing the cache entry from the LRU linked list and inserting the removed cache entry in a tail position of the LRU linked list.

If, however, the scheduling unit owner 420 of the accessed cache entry is not the current scheduling unit performing the access, by taking no action.

It is noted that the operations of FIG. 7 do not require a spinlock (since only one user thread is executed at a time). One or more aspects of the disclosure recognize that a large percentage majority of accesses to any specific metadata page will be done within the same scheduling unit instance (and thus are valid and lockless). Occasionally, however, a page accessed by one scheduling unit may be located inside a foreign LRU linked list (e.g., the cache entry is owned by another scheduling unit) (e.g. the metadata page that is accessed from a different metadata units or the metadata units was migrated to another scheduling unit, for example.). This situation is addressed in some embodiments using the scheduling unit owner 420 associated with each cache entry 400.

On any repeatable access to a given page, the scheduling unit owner 420 property is compared with the current scheduling unit, and the two scheduling units are the same, a regular lockless LRU linked list update is performed, in the first step of FIG. 7. If, however, the two scheduling units are not the same, the LRU operation is skipped, as indicated above. Practically, this may mean that the “last access” time of the page will not be reflected in the foreign LRU linked list, so a lifetime of this page may be unfairly shortened (which is assumed to be a rare event).

Nonetheless, if the tradeoff above is unacceptable, the accessing scheduling unit may notify the scheduling unit owner 420 about the access, so that the corresponding foreign LRU linked list is updated. A ring buffer or single linked list of foreign requests may be maintained for each LRU linked list. The cache entry access process 700 may be updated to access the cache entry in the foreign LRU linked list by inserting an entry reference (e.g., a pointer) to a head position of a foreign requests list (or buffer) (instead of directly moving the LRU entry to the tail position inside the foreign LRU linked list). Such operation requires an atomic operation (for a ring buffer implementation) or a spinlock for a foreign requests list. Each time an LRU access is called, the foreign requests list (or buffer) of the foreign scheduling unit is checked and if not empty (unlikely), the foreign requests listed entries are processed (e.g., moved to a tail position of the LRU linked list).

FIG. 8 illustrates exemplary pseudocode for an LRU linked list rebalancing process 800 in accordance with an illustrative embodiment. One or more aspects of the disclosure recognize that the disclosed LRU partitioning approach, that provides a LRU linked list for each scheduling unit, may exhibit different access rates from different user threads, causing different LRU lists lengths. In addition, unfair non-uniform retention times may occur among user threads (e.g., different page lifetime in different user threads or metadata units), reducing cache efficiency.

In the example of FIG. 8, for each scheduling unit, the LRU linked list rebalancing process 800 obtains the corresponding list size counter 465 and evictions counter 470 (e.g., a number of eviction events during a last monitoring interval) and calculates a retention time metric as the list size counter 465 divided by the evictions counter 470.

The LRU linked list rebalancing process 800 then calculates an average retention time across all of the scheduling units of the storage node. For each scheduling unit, the LRU linked list rebalancing process 800 calculates a deviation from the calculated average retention time. If the deviation exceeds a designated threshold, (i) a target LRU linked list size is calculated that provides the average retention time; (ii) LRU linked list candidates are selected for donation based on the retention time metric and (iii) the selected LRU linked list candidates are stored in the donation target list 475 of the current scheduling unit. The LRU linked list candidates may be selected based at least in part on the LRU lists with the least retention time, from those that were not assigned as a donation destination in the current cycle of the LRU linked list rebalancing process 800.

The target LRU linked list size may be calculated as the product of the average retention time across all of the scheduling units and the evictions counter 470. The number of entries to donate 480 may be calculated, as follows:

$$Number of Entries to Donate = ( ListSize Counter 465 - Average Retention Time ) * Evictions Counter 470$$

For each access of an LRU linked list (e.g., in connection with FIGS. 5 through 7), the LRU linked list rebalancing process 800 performs the following steps: (1) if the number of entries to donate 480 is not zero: the corresponding number of entries are detached from the head position of the LRU linked list, the detached entries are placed in the donation list 460 of the scheduling unit identified in the donation target list 475 of the current scheduling unit and the number of entries to donate is reset to zero; and (2) if donation list 460 is not empty: attach entries chain from the donation list 460 to the head position of the LRU linked list and set the donation list 460 to empty.

It is noted that the operations of FIG. 8 do not require a spinlock (since only one user thread is executed at a time).

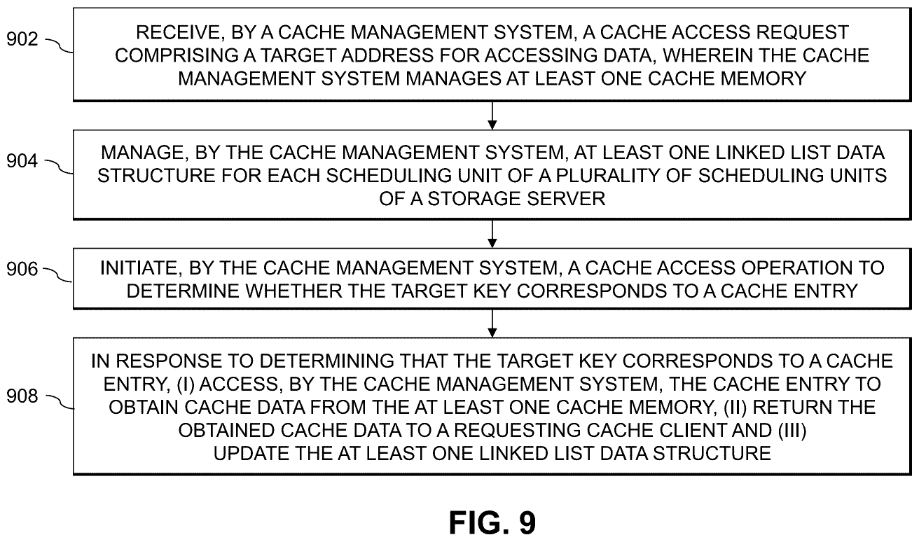

FIG. 9 is a flow diagram illustrating an exemplary implementation of a method for managing a cache using one or more linked list data structures for each scheduling unit in accordance with an illustrative embodiment. In the example of FIG. 9, a cache management system receives a cache access request in step 902 comprising a target address for accessing data, wherein the cache management system manages at least one cache memory.

The cache management system manages, in step 904, at least one least linked list data structure for each scheduling unit of a plurality of scheduling units of a storage server. The cache management system initiates, in step 906, a cache access operation to determine whether the target address corresponds to a cache entry (for example, using a hash table, where a key is applied as an input and the output is a pointer to a cache entry, or no entry).

In step 908, in response to determining that the target address corresponds to a cache entry, the process of FIG. 9 (i) accesses, by the cache management system, the cache entry to obtain cache data from the at least one cache memory, (ii) returns the obtained cache data to a requesting cache client and (iii) updates the at least one linked list data structure.

In some embodiments, the at least one linked list data structure may comprise at least one LRU linked list data structure, and the updating the at least one LRU linked list data structure may comprise removing, by the cache management system, a list element corresponding to the accessed cache entry from the at least one LRU linked list data structure and inserting, by the cache management system, a list element corresponding to the accessed cache entry to a tail position of the at least one LRU linked list data structure. The process of FIG. 9 may further comprise, in response to determining that the target address does not correspond to a cache entry, allocating a new entry in the at least one cache memory; initiating a reading of a corresponding page from a backend storage device using the target address to obtain data; and returning the obtained data to the requesting cache client.

In one or more embodiments, the at least one linked list data structure may comprise at least one LRU linked list data structure, and the process of FIG. 9 further comprises, for a given scheduling unit of the plurality of scheduling units of the storage server: calculating a deviation of a retention time metric of the given scheduling unit from an average retention time for the plurality of scheduling units; calculating, in response to the deviation exceeding a designated threshold, a target list size for the at least one LRU linked list data structure that provides the average retention time; and selecting one or more list elements, from the at least one LRU linked list data structure, for donation to another scheduling unit based at least in part on the retention time metric of the given scheduling unit. The process of FIG. 9 may further comprise, for the given scheduling unit, in response to a number of list elements to donate not being zero, (i) one or more list elements may be removed from the at least one LRU linked list data structure from a head position of the at least one LRU linked list data structure, and (ii) the selected one or more list elements for donation to another scheduling unit may be placed in a donation list of a designated target scheduling unit. The process of FIG. 9 may further comprise, for the given scheduling unit, in response to a donation list of the given scheduling unit not being empty, (i) one or more entries from the donation list may be attached to a head position of the at least one LRU linked list data structure and (ii) the donation list may be cleared.

The particular processing operations and other network functionality described in conjunction with the diagrams of FIGS. 3 and 5 through 9 are presented by way of illustrative example only and should not be construed as limiting the scope of the disclosure in any way. Alternative embodiments can use other types of processing operations for managing a cache using one or more linked list data structures for each scheduling unit. For example, the ordering of the process steps may be varied in other embodiments, or certain steps may be performed concurrently with one another rather than serially. In one aspect, the process can skip one or more of the steps. In other aspects, one or more of the steps are performed simultaneously. The processing of one or more of the steps can also be distributed between multiple components. In some aspects, additional steps can be performed.

In one or more embodiments, an access to metadata may be made through a metadata cache (e.g., if a given storage flow needs one or more metadata pages, the given storage flow issues a cache access request, and finally obtains a pointer to the desired one or more metadata pages in the cache memory. If the requested metadata page is present in the cache memory (sometimes referred to as a cache hit), then there is no need to allocate a new cache entry. If the requested metadata page is not in the cache memory then a new entry is allocated, as discussed above in conjunction with FIG. 5, the requested metadata page is read from a backend storage device (e.g., an SSD); and the storage flow that issued the cache access request obtains the pointer to the requested metadata page in the cache memory. The cache access request (e.g., a request to access a metadata page that is located in the cache) may be triggered by a storage flow, such as a user I/O operation (e.g., from a storage front end), a merge operation, a destaging operation, a garbage collection operation and/or a scrubbing operation. The scheduling unit may comprise a queue of user threads that execute one or more I/O operations of a metadata unit associated with the scheduling unit.

One or more embodiments of the disclosure provide improved methods, apparatus and computer program products for managing a cache using one or more linked list data structures for each scheduling unit. The foregoing applications and associated embodiments should be considered as illustrative only, and numerous other embodiments can be configured using the techniques disclosed herein, in a wide variety of different applications.

It should also be understood that the disclosed per-scheduling unit linked list cache management techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for managing a cache using one or more linked list data structures for each scheduling unit may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based per-scheduling unit linked list cache management engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based per-scheduling unit linked list cache management platform in illustrative embodiments. The cloud-based systems can include block storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

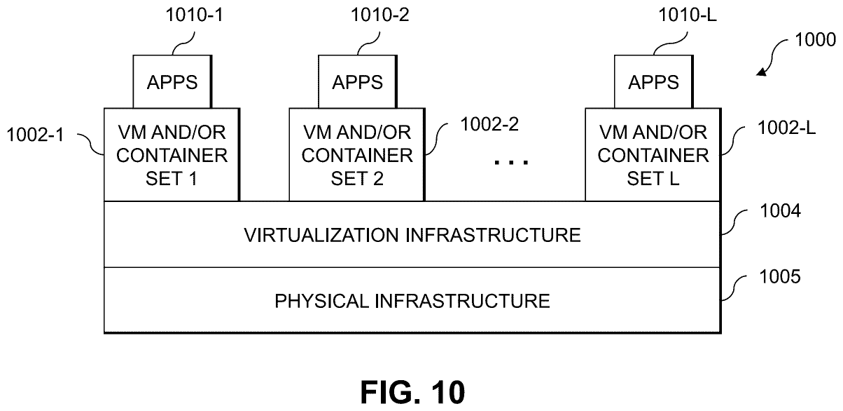

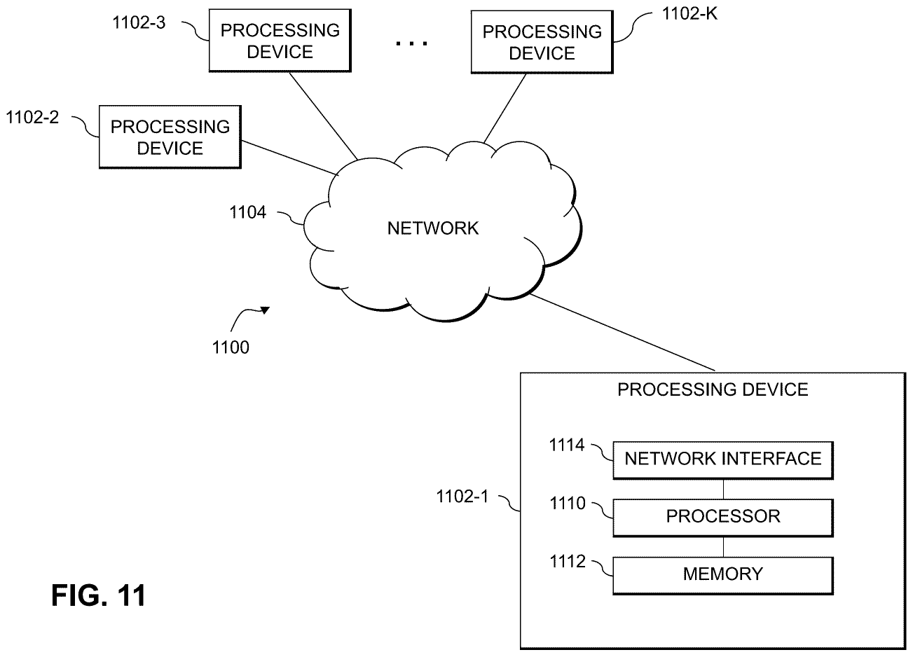

Illustrative embodiments of processing platforms will now be described in greater detail with reference to FIGS. 10 and 11. These platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of an information processing system. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. Such implementations can provide per-scheduling unit linked list cache management functionality of the type described above for one or more processes running on a given one of the VMs. For example, each of the VMs can implement per-scheduling unit linked list cache management control logic and associated functionality for managing a cache.

An example of a hypervisor platform that may be used to implement a hypervisor within the virtualization infrastructure 1004 is a compute virtualization platform which may have an associated virtual infrastructure management system such as server management software. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system. Such implementations can provide per-scheduling unit linked list cache management functionality of the type described above for one or more processes running on different ones of the containers. For example, a container host device supporting multiple containers of one or more container sets can implement one or more instances of per-scheduling unit linked list cache management control logic and associated functionality for managing a cache.

As is apparent from the above, one or more of the processing modules or other components of the information processing system may each run on a computer, server, storage device or other processing platform element. A given such element may be viewed as an example of what is more generally referred to herein as a processing device. The cloud infrastructure 1000 shown in FIG. 10 may represent at least a portion of one processing platform. Another example of such a processing platform is processing platform 1100 shown in FIG. 11.

The processing platform 1100 in this embodiment comprises at least a portion of the given system and includes a plurality of processing devices, denoted 1102-1, 1102-2, 1102-3, . . . 1102-K, which communicate with one another over a network 1104. The network 1104 may comprise any type of network, such as a WAN, a LAN, a satellite network, a telephone or cable network, a cellular network, a wireless network such as WiFi or WiMAX, or various portions or combinations of these and other types of networks.

The processing device 1102-1 in the processing platform 1100 comprises a processor 1110 coupled to a memory 1112. The processor 1110 may comprise a microprocessor, a microcontroller, an application specific integrated circuit (ASIC), a field programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements, and the memory 1112, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 10 or 11, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
receiving, by a cache management system, a cache access request comprising a target address for accessing data, wherein the cache management system manages at least one cache memory;
managing, by the cache management system, at least one linked list data structure for each scheduling unit of a plurality of scheduling units of a storage server;
initiating, by the cache management system, a cache access operation to determine whether the target address corresponds to a cache entry; and
in response to determining that the target address corresponds to a cache entry, (i) accessing, by the cache management system, the cache entry to obtain cache data from the at least one cache memory, (ii) returning the obtained cache data to a requesting cache client and (iii) updating the at least one linked list data structure;
wherein the method is performed by at least one processing device comprising a processor coupled to a memory.

2. The method of claim 1, wherein the at least one linked list data structure comprises at least one least recently used (LRU) linked list data structure, and wherein the updating the at least one LRU linked list data structure comprises removing, by the cache management system, a list element corresponding to the accessed cache entry from the at least one LRU linked list data structure and inserting, by the cache management system, a list element corresponding to the accessed cache entry to a tail position of the at least one LRU linked list data structure.

3. The method of claim 1, further comprising, in response to determining that the target address does not correspond to a cache entry, allocating a new entry in the at least one cache memory; initiating a reading of a corresponding page from a backend storage device using the target address to obtain data; and returning the obtained data to the requesting cache client.

4. The method of claim 1, wherein the scheduling unit comprises a queue of user threads that execute one or more I/O operations of a metadata unit associated with the scheduling unit.

5. The method of claim 1, wherein the at least one linked list data structure comprises at least one LRU linked list data structure, and further comprising, for a given scheduling unit of the plurality of scheduling units of the storage server:
calculating a deviation of a retention time metric of the given scheduling unit from an average retention time for the plurality of scheduling units;
calculating, in response to the deviation exceeding a designated threshold, a target list size for the at least one LRU linked list data structure that provides the average retention time; and
selecting one or more list elements, from the at least one LRU linked list data structure, for donation to another scheduling unit based at least in part on the retention time metric of the given scheduling unit.

6. The method of claim 5, further comprising, for the given scheduling unit, in response to a number of list elements to donate not being zero, (i) removing one or more list elements from the at least one LRU linked list data structure from a head position of the at least one LRU linked list data structure, and (ii) placing the selected one or more list elements for donation to another scheduling unit in a donation list of a designated target scheduling unit.

7. The method of claim 5, further comprising, for the given scheduling unit, in response to a donation list of the given scheduling unit not being empty, (i) attaching one or more entries from the donation list to a head position of the at least one LRU linked list data structure and (ii) clearing the donation list.

8. An apparatus comprising:
at least one processing device comprising a processor coupled to a memory;
the at least one processing device being configured to implement the following steps:
receiving, by a cache management system, a cache access request comprising a target address for accessing data, wherein the cache management system manages at least one cache memory;
managing, by the cache management system, at least one linked list data structure for each scheduling unit of a plurality of scheduling units of a storage server;
initiating, by the cache management system, a cache access operation to determine whether the target address corresponds to a cache entry; and
in response to determining that the target address corresponds to a cache entry, (i) accessing, by the cache management system, the cache entry to obtain cache data from the at least one cache memory, (ii) returning the obtained cache data to a requesting cache client and (iii) updating the at least one linked list data structure.

9. The apparatus of claim 8, wherein the at least one linked list data structure comprises at least one least recently used (LRU) linked list data structure, and wherein the updating the at least one LRU linked list data structure comprises removing, by the cache management system, a list element corresponding to the accessed cache entry from the at least one LRU linked list data structure and inserting, by the cache management system, a list element corresponding to the accessed cache entry to a tail position of the at least one LRU linked list data structure.

10. The apparatus of claim 8, further comprising, in response to determining that the target address does not correspond to a cache entry, allocating a new entry in the at least one cache memory; initiating a reading of a corresponding page from a backend storage device using the target address to obtain data; and returning the obtained data to the requesting cache client.

11. The apparatus of claim 8, wherein the scheduling unit comprises a queue of user threads that execute one or more I/O operations of a metadata unit associated with the scheduling unit.

12. The apparatus of claim 8, wherein the at least one linked list data structure comprises at least one LRU linked list data structure, and further comprising, for a given scheduling unit of the plurality of scheduling units of the storage server:
calculating a deviation of a retention time metric of the given scheduling unit from an average retention time for the plurality of scheduling units;
calculating, in response to the deviation exceeding a designated threshold, a target list size for the at least one LRU linked list data structure that provides the average retention time; and
selecting one or more list elements, from the at least one LRU linked list data structure, for donation to another scheduling unit based at least in part on the retention time metric of the given scheduling unit.

13. The apparatus of claim 12, further comprising, for the given scheduling unit, in response to a number of list elements to donate not being zero, (i) removing one or more list elements from the at least one LRU linked list data structure from a head position of the at least one LRU linked list data structure, and (ii) placing the selected one or more list elements for donation to another scheduling unit in a donation list of a designated target scheduling unit.

14. The apparatus of claim 12, further comprising, for the given scheduling unit, in response to a donation list of the given scheduling unit not being empty, (i) attaching one or more entries from the donation list to a head position of the at least one LRU linked list data structure and (ii) clearing the donation list.

15. A non-transitory processor-readable storage medium having stored therein program code of one or more software programs, wherein the program code when executed by at least one processing device causes the at least one processing device to perform the following steps:
receiving, by a cache management system, a cache access request comprising a target address for accessing data, wherein the cache management system manages at least one cache memory;
managing, by the cache management system, at least one linked list data structure for each scheduling unit of a plurality of scheduling units of a storage server;
initiating, by the cache management system, a cache access operation to determine whether the target address corresponds to a cache entry; and
in response to determining that the target address corresponds to a cache entry, (i) accessing, by the cache management system, the cache entry to obtain cache data from the at least one cache memory, (ii) returning the obtained cache data to a requesting cache client and (iii) updating the at least one linked list data structure.

16. The non-transitory processor-readable storage medium of claim 15, wherein the at least one linked list data structure comprises at least one least recently used (LRU) linked list data structure, and wherein the updating the at least one LRU linked list data structure comprises removing, by the cache management system, a list element corresponding to the accessed cache entry from the at least one LRU linked list data structure and inserting, by the cache management system, a list element corresponding to the accessed cache entry to a tail position of the at least one LRU linked list data structure.

17. The non-transitory processor-readable storage medium of claim 15, further comprising, in response to determining that the target address does not correspond to a cache entry, allocating a new entry in the at least one cache memory; initiating a reading of a corresponding page from a backend storage device using the target address to obtain data; and returning the obtained data to the requesting cache client.

18. The non-transitory processor-readable storage medium of claim 15, wherein the at least one linked list data structure comprises at least one LRU linked list data structure, and further comprising, for a given scheduling unit of the plurality of scheduling units of the storage server:
calculating a deviation of a retention time metric of the given scheduling unit from an average retention time for the plurality of scheduling units;
calculating, in response to the deviation exceeding a designated threshold, a target list size for the at least one LRU linked list data structure that provides the average retention time; and
selecting one or more list elements, from the at least one LRU linked list data structure, for donation to another scheduling unit based at least in part on the retention time metric of the given scheduling unit.

19. The non-transitory processor-readable storage medium of claim 18, further comprising, for the given scheduling unit, in response to a number of list elements to donate not being zero, (i) removing one or more list elements from the at least one LRU linked list data structure from a head position of the at least one LRU linked list data structure, and (ii) placing the selected one or more list elements for donation to another scheduling unit in a donation list of a designated target scheduling unit.

20. The non-transitory processor-readable storage medium of claim 18, further comprising, for the given scheduling unit, in response to a donation list of the given scheduling unit not being empty, (i) attaching one or more entries from the donation list to a head position of the at least one LRU linked list data structure and (ii) clearing the donation list.
